(19) United States
(12) Patent Application Publication
(10) Pub. No.: US 2004/0035091 A1
(43) Pub. Date: Feb. 26, 2004

(54) Dust-removing device for the filtering tube of a dust-collecting apparatus

(76) Inventor: Chun Hsiang Wang, Taipei (TW)

Correspondence Address: Chun-Hsiang Wang, PO Box 82-144, TAIPEI, TW

(21) Appl. No.: 10/224,614

(22) Filed: Aug. 21, 2002

(51) Int. Cl. B01D 46/00

(52) U.S. Cl. 55/283; 55/302

(57) ABSTRACT

A dust-removing device for the filtering tube of a dust-collecting apparatus is disclosed. The dust-removing device is provided with a controller and a high pressurized air storage tank, and the tank employs a control valve to connect the nozzle tubes corresponding to the filtering tubes. The controller makes use of the vacuum detector to determine the blockage condition of dust in the filtering tubes so as to open the control valve to clean away the dust on the dust-filtering tubes. The dust-removing device thus automatically cleans away the dust and maintains a clean dust-collecting apparatus, whereby the longevity of the device is prolonged.

### BACKGROUND OF THE INVENTION

(a) Technical Field of the Invention The present invention relates to the technology of dust-removing within a dust-collecting apparatus, and in particular, a dust-removing device which can automatic detect the dust blockage of the filtering tubes of the dust-collecting apparatus and clean away the dust.

(b) Description of the Prior Art

Dust-collecting apparatus is an essential and important electrical appliance in removing dust particles in work sites such as furniture manufacturing plant, saw-mill plant or sand and quarry industries to remove the high content of dust particles in the air. Thus, the workers at the work site can breathe in cleaner air so as to keep a healthy body. After the apparatus has been used and deployed for a while, the apparatus has to be dismantled to clean away the dust particles that blocking the filtering tubes. However, such dismantling of the apparatus is not economical and the procedures of the dismantling are laborious and complicated. In addition, the dust that collected has to be cleaned using high pressurized air and this again will cause another pollution to the air. In view of the above, it is an object of the present invention to provide a dust-removing device for the filtering tube of a dust-collecting apparatus which can solve the above-mentioned drawbacks.

### SUMMARY OF THE INVENTION

Accordingly, it is an object of the present invention to provide a dust-removing device for the filtering tube of a dust-collecting apparatus having a filtering means arranged with rows of hollow filtering tubes and a dust-suction hole being positioned at one side of the dust-collecting apparatus to communicate with the interior of the apparatus and the interior of the apparatus being formed with an air-outlet channel and a blower positioned in alignment with the channel, and an air discharge tube for the filtered air at the housing of the apparatus, wherein a dust-removing device is mounted on the dust-collecting apparatus and the housing of the apparatus is provided with a controller connected with a vacuum detector positioned at the air-outlet channel, and the apparatus is provided with a high pressure storage tank connected to an air source, and the high pressure storage tank is mounted with a control valve controlling by a controller and the control valve is connected to a series of nozzle tubes corresponding to the filtering tube, and the nozzle tubes is provided with a plurality of air holes corresponding to the interior of the filtering tubes; thereby a dust-removing device which can self-cleaning of the filtering tubes of the dust-collecting apparatus.

Another object of the present invention is to provide a dust-removing device for the filtering tube of a dust-collecting apparatus, wherein the high pressurized air storage tank is locked within the interior of the dust-collecting apparatus by means of a locking plate.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view of a dust-removing device for the filtering tube of a dust-collecting apparatus, showing the relative positions of the components constituted the device in accordance with the present invention.

FIG. 2 is a schematic view of a dust-removing device for the filtering tube of a dust-collecting apparatus, showing the interior of the device and the action of vacuuming in accordance with the present invention.

FIG. 3 is a further schematic view of a dust-removing device for the filtering tube of a dust-collecting apparatus, further the action of vacuuming in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

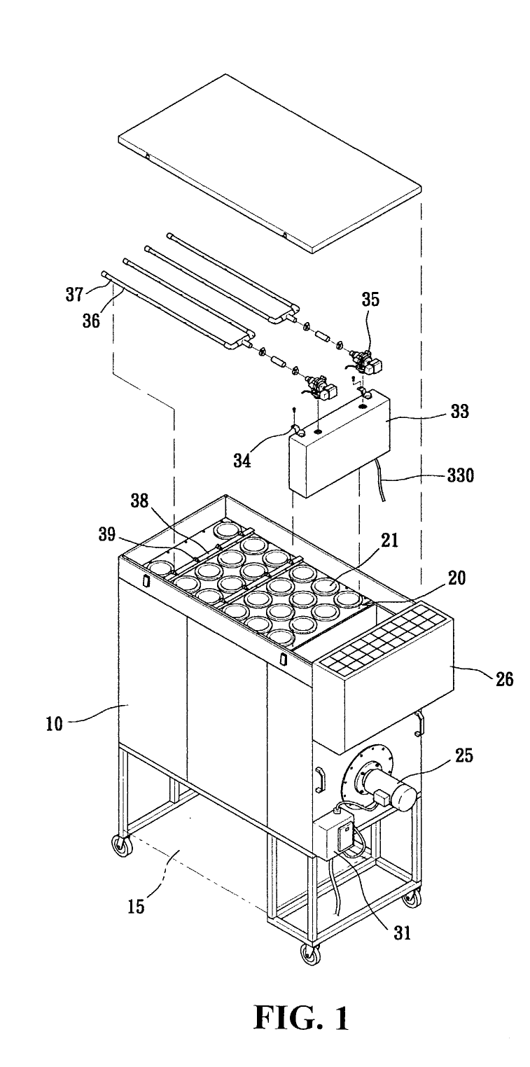

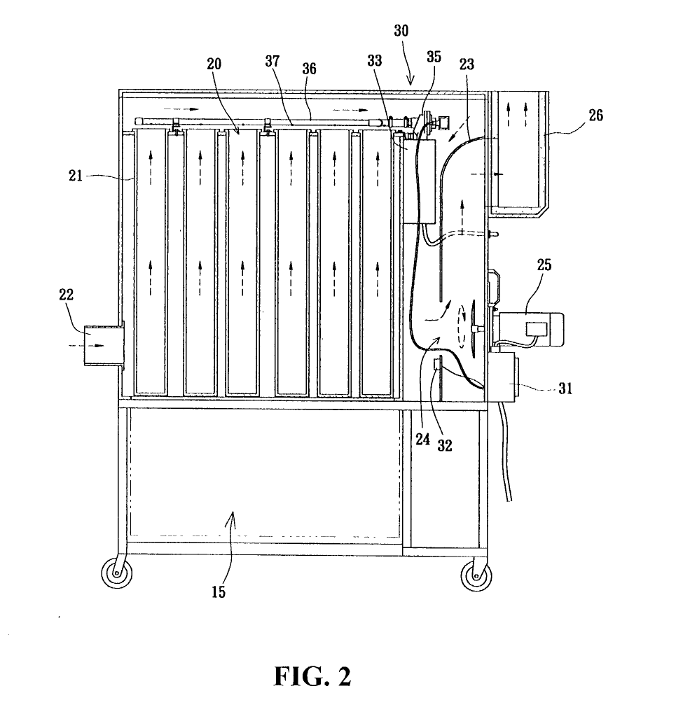

In accordance with the present invention, as shown in FIGS. 1 and 2, there is shown a dust-removing device for the filtering tubes of a dust-collecting apparatus having a body 10 installed with a filtering device 20. The lower section of the filtering device 20 is positioned with a dust-collection box 15 for collection of the filtered dust from the filtering device 20, and the filtering device 20 is provided with a plurality of hollow filtering tubes 21 arranged in rows. One side of the body 10 of the dust-collecting apparatus is provide with a dust-suction hole 22 connected to the interior of the body 10 and a partition board 23 is used to form an air outlet channel 24 within the body 10. A blower 25 is positioned on the body 10 corresponding to the air outlet channel 24, and thus, when the blower 25 rotates, the dust at the surrounding is sucked to the body 10 of the dust collecting device via the dust suction hole 22 and is filtered by the filtering tubes 21 such that the dust will be collected in the dust-collection box 15. The filtered air is discharged via the filtering tubes 21 and the air outlet channel 24.

Referring again to FIGS. 1 and 2, the body 10 of the dust-collection apparatus is provided with a dust-removing device 30 and the device 30 is provided with a controller 31 at the housing thereof. The controller 31 is connected to a vacuum detector 32 positioned onto a partition board 23, and the body 10 makes use of a locking plate 34 to lock a high pressurized air storage tank 33 at one side of the filtering tubes 21. The storage tank 33 is connected to the high pressurized air source of the air compressor via an air transporting tube 330.

There are a plurality of control valves 35 on the high pressurized air storage tank 33 and the control valves 35 are used to connect to the nozzle tubes 36 corresponding to the filtering tubes 21, and the nozzle tubes 36, corresponding to the interior of the air hole 37, forms into corresponding air holes 37 so that the high pressurized air is blown into the interior of the filtering tubes 21 through the air hole 37. In addition, on the upper section of the filtering tubes 21 of the body 10, a plurality of fixing rods 38 are provided and the fixing rod 38 is provided with a plurality of positioning clips 39 which can clip the nozzle tubes 36 and to support and to hold the nozzle tubes 36.

In view of the above, the high pressurized air is blown into the filtering tubes 21 and the high pressurized air is blown from the interior of the filtering tubes 21 to the exterior and the dust adhered to the filtering tubes is blown off to be collected within the dust-collection box 15. Thus, a dust-removing device for the filtering tubes of a dust-collecting apparatus is obtained.

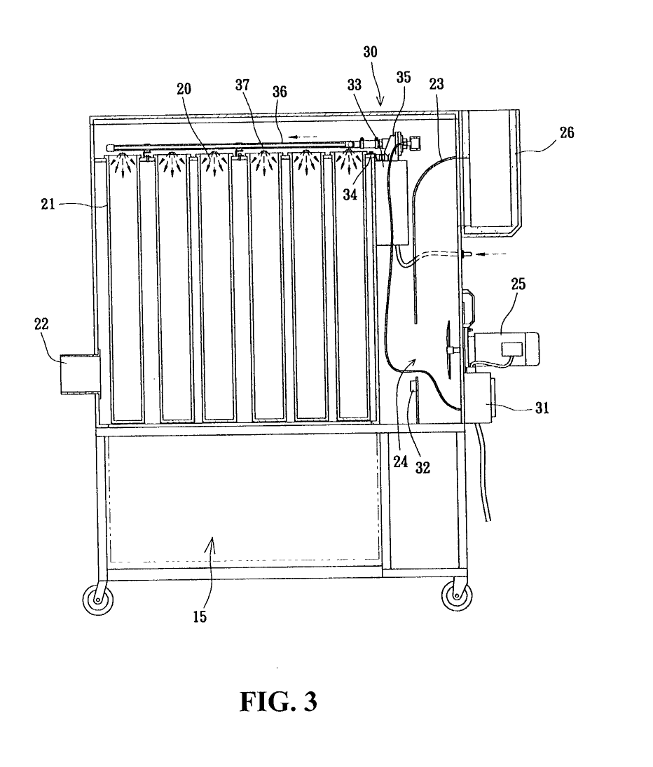

In application, as shown in FIGS. 2 and 3, after the blower 25 is in operation for a while, dust particles are sucked into via the dust-suction hole 22 and filtered by the filtering tubes, and the filtered air is discharged from the air-outlet channel 24 via the discharged tube 26, and after in operation for a while, the dust particles will be collected at the external wall of the filtering tube 21. When the dust particles are collected to a certain extent and the blower 25 continues to suck air, the interior of the air outlet channel 24 is closed to vacuum. As a result when vacuum is formed at the channel 24 and is detected by the vacuum detector 32 at a certain value, it indicates that the filtering tubes 21 need to be cleaned. At this instance, the vacuum detector 32 will emit a signal to inform the controller 31 and the controller 31 will shut off the blower 25 and cause the opening of the control valve 35 on the high pressurized air storage tank 33 and the high pressurized air will be ejected via the air hole 37 of the nozzle tubes 36 to the interior of the filtering tubes 21 (as shown in FIG. 3) and the high pressurized air is blown to the exterior via the interior of the filtering tube 21 and the adhered dust particles on the external wall of the filtering tubes 21 will be blown off. The dust-collection box 15 is used at the same time for the collection of the dust particles so as to keep the environment clean. When the dust particles have been cleaned for a while, the blower 25 is switched on again and the control valve 35 is shut off.

The advantages of the dust-removing device for the filtering tubes of a dust-collecting apparatus in accordance with the present invention are as follows:

(1) The cleaning of the dust particles is automatic. By employing the vacuum detector 32 at the air-outlet channel 24, when the filtering tubes 21 are blocked by dust particles at a certain extent, the controller will be switched on to stop the operation of the blower 25 and to initiate the control valve 35 and a high pressurized air is used to clean away the dust particles on the filtering tube 21.

(2) The dust-collection efficiency is maintained. In view of the above automatic cleaning of the filtering tubes 21, the dust-collection efficiency of the dust-collection apparatus is always maintained to an optimal level.

(3) The environment is kept clean in the course of cleaning of the dust particles. As the dust-collecting apparatus does not need to be dismantled and therefore the dust particles that have been collected will not exposed to the environment to affect the health of the workers on the work sites.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dust-removing device for the filtering tube of a dust-collecting apparatus having a filtering means arranged with rows of hollow filtering tubes and a dust-suction hole being positioned at one side of the dust-collecting apparatus to communicate with the interior of the apparatus and the interior of the apparatus being formed with an air-outlet channel and a blower positioned in alignment with the channel, and an air discharge tube for the filtered air at the housing of the apparatus, characterized in that a dust-removing device is mounted on the dust-collecting apparatus and the housing of the apparatus is provided with a controller connected with a vacuum detector positioned at the air-outlet channel, and the apparatus is provided with a high pressure storage tank connected to an air source, and the high pressure storage tank is mounted with a control valve controlling by a controller and the control valve is connected to a series of nozzle tubes corresponding to the filtering tube, and the nozzle tubes is provided with a plurality of air holes corresponding to the interior of the filtering tubes; thereby a dust-removing device which can self-cleaning of the filtering tubes of the dust-collecting apparatus.

2. The dust-removing device for the filtering tube of claim 1, wherein the high pressurized air storage tank is locked within the interior of the dust-collecting apparatus by means of a locking plate.

3. The dust-removing device for the filtering tube of claim 1, wherein the high pressurized air storage tank is a high pressurized air source and is connected to an air compressor by an air transporting tube.

4. The dust-removing device for the filtering tube of claim 1, wherein the filtering tubes on the dust-collecting apparatus is provided with a plurality of securing rods having positioning clips for clipping nozzle tubes to support the nozzle tubes.
